(19) United States
(12) Patent Application Publication
(10) Pub. No.: US 2024/0004854 A1
(43) Pub. Date: Jan. 4, 2024

(54) SYSTEM AND METHOD FOR CREATING AND MAINTAINING A QUANTIZED MULTI-DIMENSIONAL DISTRIBUTED HASH TABLE

(71) Applicant: Holo, Ltd, (US)

(72) Inventors: Arthur Brock, Parker, CO (US); Timothy Carlin-Burns, Woodstock, NY (US); Michael Dougherty, Portland, OR (US)

(21) Appl. No.: 18/216,370

(22) Filed: Jun. 29, 2023

Related U.S. Application Data
(60) Provisional application No. 63/356,709, filed on Jun. 29, 2022.

(51) Int. Cl. G06F 16/22; G06F 21/60

(52) U.S. Cl. CPC G06F 16/2264; G06F 16/2255; G06F 21/602

(57) ABSTRACT

This disclosure describes a system including nodes coordinating via a distributed hash table. In one embodiment, the distributed hash table is a multi-dimensional hash table with at least one dimension associated with a network location (“space”), and a second dimension corresponding to time, where the rectangular regions of space-time are aggregated and compared in order to effectively isolate differing information between nodes for synchronization. Methods and systems are also described for resizing the arcs associated with different nodes as nodes enter and leave the system.

### CROSS-REFERENCE TO RELATED APPLICATIONS

The present application claims priority to and benefit of U.S. Provisional Patent Application No. 63/356,709, filed on Jun. 29, 2022, the disclosure of which is hereby incorporated by reference herein in its entirety.

### TECHNICAL FIELD

The present disclosure relates generally to distributed computing, and more particularly to a system for finding and returning connections or content from one or more nodes in a sparsely-connected multi-node computing system where no single node has a comprehensive index of nodes or content managed by those nodes, commonly known as a “distributed hash table” or DHT.

### BACKGROUND

A hash table is a data structure that associates keys to values. The elements of a hash table are a hash function and a set of “buckets”, or areas or structures used to store the value associated with a key. The hash function deterministically translates a retrieval request using the key into an bucket identifier where the value can be found. The range of numbers that can be returned by a hash is known—generally the set of integers equal to 2^{x}, where x is the length of the hash output. This range of possible values is the keyspace. The hash table partitions the keyspace into a number of buckets smaller than the keyspace. The keyspace is further usually characterized as a “ring”, where the highest values assignable in the hash “wrap around” to be adjacent to the lowest values assignable in the hash; a bucket may overlap with the transition from the highest to lowest value.

In typical practice, values are stored in the data structure by using the hash function to compute an index (the bucket identifier) into an array in memory or on disk (the buckets), where the value is stored. A client using the hash table can efficiently retrieve the value associated with a given key by repeating the process of hashing the key, finding the index associated with the key, and retrieving the value.

A distributed hash table is a distributed system that performs the same function—associating keys to values—across more than one node. Instead of having a single data structure, all participating nodes have a common hash function that allows them to compute the bucket identifier. The system then requests the value associated with the key from the node corresponding to the identifier.

One significant difference between regular hash tables and DHTs is that distributed systems generally need a mechanism for discovery—that is, finding other nodes in the network based upon some criteria. When state values are being replicated, or messages are being exchanged, each node needs to know how to reach other nodes participating in the distributed system. As nodes enter or leave, their network location (as identified by an IP address or similar) can and frequently does change. For this reason DHTs also usually have an additional mechanism that is not in regular hash tables: a way of associating or finding a node address given a bucket identifier. For this reason, a DHT will typically use the term “node identifier” (or just “node”) rather than “bucket” to emphasize the need to reach out across the distributed system and retrieve the value from an identified node.

Because the nodes in a DHT are in different locations, various implementations can choose hash functions that result in different properties. Some hash functions are chosen to spread values evenly across the available nodes. Other hash functions are chosen to maintain consistency and minimize key to address mapping changes as nodes enter and leave the network. Others are chosen to maximize locality of data and to place similar values “nearby” each other. It is not always necessary that all possible values be stored in the DHT; in some cases it may be enough to have a shared formula by which a value can be calculated from a particular key.

The simplest way to handle addressing is for all nodes to have a list of other participating nodes, or to have a known “name node” that keeps track of the address information for all participating nodes. This is a solution for systems where the number of nodes is known, and where nodes like the name node can be trusted. But if nodes cannot necessarily be trusted, or if nodes are transient, a different solution can be used.

Other existing systems don't keep an updated list of all clients, but instead have a shared method of locating the node that corresponds to a key. For example, in a DHT using the Chord algorithm, as nodes come online they distinguish their position within the ring based on some identity function. Once the node knows its place in the ring, it calculates the address of the nodes immediately to its left and right, traversing the ring in clockwise fashion, to become a part of the ring chain. As a node goes offline, it tries to notify its connections, but in the case of failure, their connections will notice the lack of connectivity and relink themselves.

When a node needs to retrieve a value, it can either perform a simple query by asking each successive node in the ring until it finds the correct node, or in can immediately jump to the nearest known node maintained in a “finger list”—a maintained list of connections to a small number of remote nodes—and continue the search there.

In an alternative implementation called Kademlia, nodes are organized into “k-buckets” according to the binary digits of their identity as identified by the shared identity function. The “distance” between to nodes is measured by the exclusive or (XOR) of two identities determines the relative closeness of another node, and a lopsided binary tree effectively means that references are maintained to a larger number of “nearby” and a smaller number of “far” nodes.

Discovery requires making a query to a node that is known about as close to the target identity as possible (based on the XOR “distance”). That node should theoretically have references to more nodes “nearby” to the desired value and can pass the request closer to the target identity. The discovery repeats until the contacted node returns the identity of the target node (i.e., the target node is being found) or no more closer nodes are found.

The state data described so far is described in terms of “nodes” and locating nodes within a system without reference to the data that may be associated with the node. However, this is not a limitation on the system. In some embodiments, the representation of the state of the data held, communicated, or coordinated by a node could be what is represented in the within the DHT. In some contexts, this is referred to as “content addressed” data. In another embodiment, both node location information and content-related information is represented in a DHT.

### BRIEF DESCRIPTION OF THE DRAWINGS

Various embodiments of the disclosed concepts are illustrated by way of example and not by way of limitation in the accompanying drawings in which like references indicate similar elements. It should be noted that references to “some” embodiments in this disclosure mean at least one embodiment and they are not necessarily the same or different embodiments. To be concise, drawings may be used to facilitate descriptions of exemplary embodiments, and not all features of an actual implementation may be provided in the drawings.

FIG. 1a shows a Holochain DHT according to one embodiment.

FIG. 1b shows a Holochain node according to one embodiment.

FIG. 2 shows the operation of a Holochain node according to one embodiment.

FIG. 3 shows a source chain according to one embodiment.

FIG. 4 shows a topological representation of an exemplary spacetime DHT is according to one embodiment.

FIG. 5 shows a representation of the chunks, chunk offsets, and arc values according to one embodiment.

FIGS. 6a, 6b, and 6c show the time field according to one embodiment.

FIGS. 7a and 7b shows storage arcs and regions according to one embodiment.

FIG. 8 shows a chunking process according to one embodiment.

FIG. 9 shows an information processing system according to one embodiment.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form to avoid obscuring the disclosure. In the interest of clarity, not all features of an actual implementation are described in this disclosure. Moreover, the language used in this disclosure has been principally selected for readability and instructional purposes and has not necessarily been selected to delineate or circumscribe the full inventive scope of the disclosed subject matter.

One common use for DHTs is to coordinate different agents that are together creating a distributed ledger. In general, a distributed ledger is a durable, multi-agent coordinated record of events that occur across a network of nodes. In most cases, the records in a distributed ledger are cryptographically signed and/or verified, with each record incorporating information from a defined root (or “genesis”) record. When constructed in this way, the distributed ledger can securely represent a multi-agent state across a network. Some of the best known distributed ledgers pertain to cryptocurrencies, such as Bitcoin or Ethereum, but other technologies also use distributed ledgers, such as update systems and source code coordination systems like Git. As described below, the cryptographic chain will be referred to as a “hash chain” or “source chain” and the combination of the source chain and the DHT will be considered a distributed ledger.

One of the fundamental issues when using a distributed ledger is how to coordinate updates between nodes, or to exchange information about the state of the distributed ledger. Various problems have been noted. Some distributed ledgers exchange the entire hash chain between participating nodes so that all nodes have a copy. Other embodiments partition the chain and exchange records about activity, such as a bloom filter. Some systems have thresholds past which all data is considered immutable, so updating information older than the threshold is not needed. But for systems that are still coordinating updates, this treats old data and new data as equivalent and is wasteful of processing power and bandwidth. Accordingly, it is desired to be able to exchange data in a way that takes up less space and/or computation for older data that is unlikely to change.

When considering that some implementations may want agents to have overlapping arcs to have redundancy in the system. However, a second problem identified in the prior art is that prior art methods of creating overlapping arcs sometimes resulted in situations where it was more difficult to coordinate state updates between overlapping arc sections. As arcs changed in size, the size of the overlap could change arbitrarily. Accordingly, it is desired to have fewer unique overlaps, so that it is easier to compare and to re-use computation.

It is further desirable that the most reliable nodes should be doing the least work. A node that has been offline will necessarily need to get updates when it comes online, but nodes that stay connected should only be computing and gossiping new data, never old data with each other.

It is also desirable for the method to be easily and correctly implemented to minimize errors and software bugs.

It is also desirable to enable compression of the data being communicated between nodes without limiting the parameters of what needs to be compressed. Different nodes may need to exchange information about different parts of the DHT, so enabling a structure that allows for the selection of compression of only the relevant data can reduce the bandwidth requirements of the system.

Various embodiments of the QDHT solve these problems. In one embodiment, QDHT arcs have predictable boundaries and can be further subdivided into easily-compared chunks, where it is possible to re-use gossip data for a given chunk across each connection that has an overlap. In another embodiment, the QDHT computes hashes of historical records for various time ranges, also organized with predictable boundaries and chunks, and gossips hashes of the records corresponding to the time ranges. In this embodiment, the system saves resources in the frequent case where those hashes do not differ between agents. The advantages described above, and others, can be achieved through the use of various embodiments of QDHT systems and methods described below.

In discussing the methods and systems described, the following terms of art are helpful:

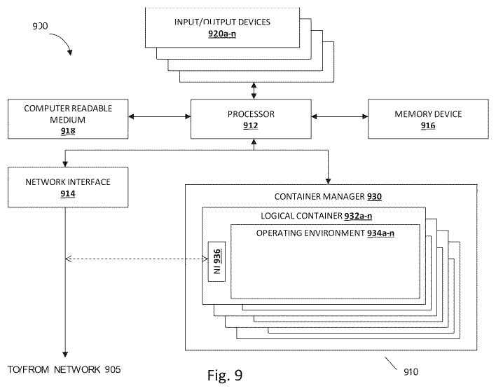

This disclosure describes a distributed system made up of a plurality of individual computing systems, each referred to as a “node.” A node is an information processing system as discussed relative to FIG. 9.

An agent is a participant in a P2P network. Agents communicate with each other to send data about each other, and about events, to each other. Agents, as described herein, are the source of events.

Each agent has a location. In a typical embodiment, there is a single agent associated with each node. Unless specified otherwise herein, this single-agent-per-node embodiment is being discussed. When there is a one-to-one mapping between nodes and agents, it may be useful as a shorthand to refer to a “node” participating in a P2P network, or an “agent address,” but these should be understood to refer to the combined capabilities of the node as an information processing system and the agent as a hardware or software system with processor-interpretable logic and instructions that, when executed by the information processing system, cause a particular result. As such, some descriptions may refer to the combined capabilities of the node and agent without confusion on the part of one skilled in the art. Other embodiments may have more than one agent associated with a node, or more than one node associated with an agent without departing from the scope of the inventions described herein.

A peer-to-peer network, sometimes referred to as a P2P network or just the “network of nodes” is a collection of agents who are able to connect to each other over the communication system (usually the Internet) for the purpose of exchanging data.

The agents (or nodes) in embodiments of the network are logically organized into a n-dimensional field as described further below. In an embodiment where the field is one-dimensional, it may be organized as a ring as described above. As more dimensions are added, each dimension may be either closed or open, and may be individually Euclidean or not; each dimension is logically separate. When all dimensions are closed, the field can be logically represented as a n-dimensional torus, but there is no requirement that all the dimensions be closed.

In some embodiments the field is two dimensional, where the first dimension relates to a node location and the second dimension relates to time. Mathematically, “time” is represented as a 1-dimensional ray with its endpoint fixed at a defined origin. In an embodiment that uses these two dimensions, an agent refers to the locations in the DHT as being organized into a geometrical “Spacetime”. Spacetime is a hybrid function representing all entities having locations and extents in space as well as in time and can be organized in relation to each other through the standard notion of Euclidean distance. Spacetime is formed by simply sweeping the circle (or n-torus) of space through time to form a cylinder (or more complex surface for higher dimensions). All entities exist somewhere on this surface. Further embodiments can include additional dimensions without departing from the intended scope of the disclosure herein.

For the purpose of simplicity and brevity, an agent will describe an embodiment where space is a one-dimensional closed field (i.e. a ring), and time is a one-dimensional ray with a set origin time. In one embodiment, the origin time is flexible and is coordinated among the nodes participating in the DHT. On other embodiments, the origin time can change as records move into the past and move past a threshold after which they are fixed. Records older than the threshold are not subject to updates and so the scope of the time axis can be minimized by having it move forward in a coordinated way. In another embodiment, the temporal dimension is defined by a logical clock such as a Lamport clock or a vector clock. In another embodiment, the origin time is fixed at a known point, such as the Unix epoch (the number of seconds that have elapsed since Jan. 1, 1970 GMT). However, that is not the only possible set of values or range for a time axis. Any subsequent geometric terms used can be extended to higher dimensions, e.g. a spacetime “rectangle” can be extended to “rectangular prism” for a system with 2 spatial dimensions instead of 1. When talking about one embodiment that uses spacetime as the 2-dimensional field, this document is just referring to various exemplary embodiments that use that two-dimensional field, unless specified otherwise. However, the descriptions of the “spacetime” embodiments do not mean that all embodiments must have that same structure unless it is specified so. Higher-dimensional-fields are also contemplated, with axes including latency, ownership, similarity, and others, including user-defined axes. For example, one embodiment combines two or more location axes to provide a three-dimensional surface (or “world surface”) corresponding to physical geography. A further embodiment extends this world surface to four dimensions, including a time dimension, so that three-dimensional movement over time can be represented as a distinct “location” within the DHT. This “worldtime” embodiment may be particularly useful for associating nodes with satellites that are orbiting the Earth. Due to the differences in time due to relativistic effects, the time axis may need to be made with reference to an object traveling at c, so that all participants can have a common reference. For the QDHT, the only requirement is that some dimension or dimensions be translatable into node locations or addresses (perhaps at a particular time) so that the nodes can gossip to each other to perform store, retrieve, or sync operations.

An “event” is a record, originating from an agent, that has been or may be added to the distributed ledger. In some embodiments, the event is correlated with one or more packets of data which are transferred from one agent to another. Each event is deterministically assigned a hash, and each hash has a definite location in space due to its association with an agent, therefore each event has a location in space. Each event also contains a timestamp which gives it a time coordinate. Thus, each event occupies a definite point (in the geometric sense) in spacetime. In some embodiments, an operation may be a discrete type of event with its own location in spacetime.

Each agent has an “arc,” which is a range over an axis that an agent is responsible for. In the case of a ring, this can be visualized by arranging the closed circle of hash values into a circle and identifying a section of the circle—the arc—where the agent is located and for which the agent will respond to “store,” “retrieve,” “sync,” and other interactions.

For ease of discussion, this document will use the term “arc” to refer to the discrete portion of the n-space that the agent manages, even when the n-space has a higher number of dimensions. A higher-dimensional arc (including at least two dimensions) may also be referred to as a “range.” Arcs and ranges can be considered a generalization of the “bucket” concept taken from hash table data structure as applied to an n-dimensional DHT. Agents may grow and shrink their arcs or ranges over time, depending on the conditions of the system. Arcs and ranges may not be sized arbitrarily; they must follow quantization rules as described below.

In some embodiments, agents may have multiple arcs assigned for different purposes. For example, in one embodiment an agent has a “storage arc” where the agent will store copies of the data that are hashed to that arc, and a broader “query arc” comprising the agent and a larger portion of the keyspace in which the agent maintains ongoing connections to its neighbors for quick connections or referrals.

A “hash” is a mapping function that takes an input and deterministically creates an output that maps onto a dimension. Most “hashes” will be chosen for properties such as those described above, however the term “hash” may be applied to any appropriate mapping function. For example a time lookup is a hash function under this definition. In some embodiments the hash output may also require a secondary mapping function (or functions) to fully translate the output of the hash to a usable representation corresponding to an axis. For example, the output of the SHA-256 hash is a 256-bit binary array. One embodiment has a secondary mapping from values associated with the SHA-256 output to a node address, such as an IP address.

In another embodiment, the implementation takes advantage of the fact that IPv6 defines unique local addresses in RFC 4193, providing a very large private address space from which each organization can randomly or pseudo-randomly allocate a 40-bit prefix, each of which allows 65536 organizational subnets. In this embodiment, some portion of the hash value is directly embedded into the local address space in the IPv6 address, allowing direct addressing of a node to occur across the network (perhaps using an overlay network or a dual-homed node).

Agents communicate (“gossip”) with each other according to a protocol. This gossip between agents is used to coordinate their individual ranges, to establish or update hash to address mappings, or to synchronize information. In some embodiments, this communication occurs in discrete “rounds.” During a round, data is exchanged amongst agents according to a protocol. Various embodiments and elements of this protocol are described below. The term “connection” or “communication” may indicate a networking communication in any type of manner, for example, through a land telephone network, a wired network, a wireless network, a mobile network, a satellite network, or a combination of the above, etc. While various embodiments may use various communication types or protocols, the inventions disclosed herein are not limited by the method or type of communication used.

Certain spacetime coordinates are “quantized”, meaning they cannot take on a continuous range of values, but must instead be selected from a discrete set of values, which are equal to a positive integer multiplication of a defined smallest value. In one spacetime embodiment, the coordinates that are quantized are the endpoints of an agent's arc and the coordinates making up a region of spacetime. The “grid” which defines the quantization is determined for each dimension separately and may be dimensionless for some axes. Different embodiments (or different dimensions) may use a different quantum size. For example, a 32-bit ring could be quantized on a bit level, a byte level, or it could be interpreted as an integer and have a smallest possible quantum size of 1. A time dimension could be quantized using a millisecond, second, minute, hour, day, or other time measurement as the quantum. The smallest quantum value defines the largest number of arcs that can be accommodated for that dimension.

In one embodiment, quantizations of increasing coarseness can be obtained by successively doubling the distance between quantized values, or equivalently, by removing every other quantized value from consideration. The number of doublings used to obtain a particular set of quantized values for a dimension is called the quantization power or simply the “power” of that dimension. A power of 0 denotes a dimension with points spaced by the chosen quantum length. A power of 1 denotes a quantization with double the spacing of power 0, meaning that half as many points are used to represent the same space.

In an embodiment where the regions are thus defined, distinct regions defined by quantizations at the same power levels do not overlap. Two regions, one of which has lower power levels in both dimensions than the other, will never partially overlap: either they will be nonoverlapping, or one region will be fully contained by the other. The only way to have partially overlapping regions is to have two regions A and B where A's space power is higher than B's, and A's time power is lower than B's

In various embodiments, arcs and ranges in QDHT do not have fractional values, but instead are moved to the next quantum boundary according to a rule (such as a rounding rule). When dividing a ring into arcs, the sizes of the arcs may thus be different sizes. For example a ring with a size of 10 quantum units may be divided into 5 equal arcs of 2 quanta each, or into three arcs, two of which are three quanta in size and one of which is four quanta in size.

To avoid having arcs of different sizes, it may be useful in some embodiments to choose a number that is easily divisible, such as an integer power of two. For ease of description, this document will describe an embodiment where the space dimension is a ring represented as an integer representable by 32 bits, i.e., the set of integers having possible values from 0 to 4,294,967,296, with 4,294,967,297 wrapping around to 0, such as per a mod function. The corresponding hash function is any cryptographically strong hash. If the output of the hash function is longer than 32 bits, the output of the hash function can be truncated to 32 bits without affecting the operation of the system.

Although the size of a quantized arc is equal to a positive integer multiplication of the smallest quantum value, it may be useful in some embodiments to not refer to interior quantum divisions. In such an embodiment, regions can only be drawn using adjacent points from each quantized dimension. In other words, a “side” of the rectangular region cannot contain more than 2 quantized points. For ease of referring to the hash space represented by an arc, it may be useful to refer to it as a “chunk.”

In one embodiment, the distributed system including the components described above is organized as a Holochain network. A Holochain network is a distributed system with content-addressed nodes, where identities, nodes, and storage elements are all addressed by cryptographic hash values. Distributed applications run across multiple nodes in the network and a particular Holochain network is organized to provide a decentralized state coordination function for a set of nodes and agents so as to protect the integrity and functionality of the distributed, decentralized applications running on the network.

The layered relationships between header, root and data, and between previous and subsequent entries can ensure data integrity in a distributed ledger. For example, when the data of a block is modified in any way, including changes to the block metadata, the hash value of the block changes. Because each subsequent block in a hash chain recursively depends upon the values in previous blocks, any subsequent entries must also have their hash values updated or the chain will be “forked,” with new values based on the new block hash value. Thus, any change in any block, from the root up to any intermediate block, will immediately be apparent upon inspection.

In one embodiment, aspects of the system for coordinating distributed computation include a plurality of nodes, each node with a processing element, a network interface, and a memory, the plurality of nodes communicatively coupled together via a network; a keyspace defined across the plurality of nodes, the keyspace having at least two discretized dimensions; wherein each node of the plurality of nodes is associated with a region of the keyspace, wherein at least one dimension of the region corresponds to a closed dimension of the keyspace using a hash function mapping inputs to points in the keyspace; and wherein a first node of the plurality of nodes and a second node of the plurality of nodes are configured to coordinate stored state by computing, at the first node, a first cryptographic fingerprint of the data associated with a first region of the keyspace, and computing, at the second node, a second cryptographic fingerprint of the data associated with a first region of the keyspace; comparing the first cryptographic fingerprint and the second cryptographic fingerprint; and when the first cryptographic fingerprint is different than the second cryptographic fingerprint, communicating a state change message from the first node to the second node. At least one dimension of the keyspace is defined by a physical or logical clock, so that the older information is updated to match the new information.

In a further embodiment, after identifying that two regions have different cryptographic signatures, partitioning the region and then comparing and coordinating the information associated with each sub-region. In one embodiment, the partitioning and comparing process is performed recursively until one or all of the dimensions are reduced to the smallest discrete value allowed.

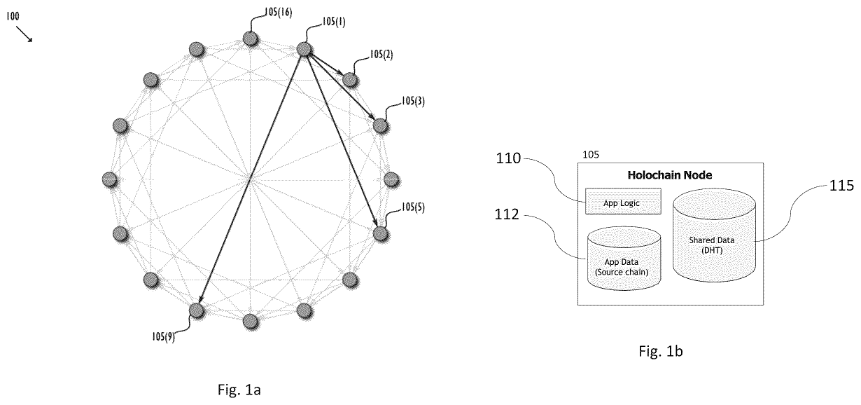

FIGS. 1a and 1b show a basic architecture of exemplary Holochain 100. With reference to FIG. 1a, one embodiment of Holochain 100 is shown with reference to one distributed application that acts across all nodes 105(1) through 105(16). Arcs are shown between the various nodes showing that they are logically connected. In one embodiment, there is a single application defined per Holochain, so Holochain 100 also refers to Application 100. Referring to FIG. 1B, in one embodiment, each node 105 of Holochain 100 includes three main sub-systems—Application Logic 110 (acting as the agent), source chain 112, and a portion of the shared DHT 115. Application Logic 110 coordinates the system to present consistent application functionality to a user or agent. Application Logic 110 may read and write local source chain 112, and it may also get data from and put authorized data onto shared DHT 115. Application Logic 110 includes validation rules for changing its local hash chain. Holochain 100 also includes other nodes connected to Application Logic 110 as shown in FIG. 1a to provide independent system-level validation for changes proposed to be entered by Application Logic 110. Copies of data from other node source chains and validation information for transactions can be also stored on the node in the portion of the shared DHT 115. Application Logic 110 may be accessed, for instance, with a web browser for a user interface. Application Logic 110 may be implemented using various programming tools, for instance, Rust, JavaScript, Lisp, Python or Go.

In one embodiment of a Holochain 100, there is a separate DHT 115 for each distinct Application Logic 110, including each version of Application Logic 110. The nodes that are participating in the DHT for Application Logic 110 maintain an individual source chain 112, containing events relative to Holochain 100 for the distributed application implemented over Holochain 100 in general and with reference to the specific agent 105. The source chain (or source DAG, as discussed below), when coordinated with other agents, is a distributed ledger. For ease of communication with other agent instances, the source chain 112 may be implemented using a local hash chain or local hash table with the keys in the local hash table being chosen to be compatible with the keys used in the multi-agent Holochain 100. In one embodiment, each entry corresponding to an event is identified by a key. In one embodiment the key for a particular event is created by hashing information from the entry, such as the header of the entry. Depending on the structure of the Holochain 100, more than one hashing operation may need to take place. For example, in one embodiment the instance of the Application logic 110 has access to a time source and a timestamp is used as a hash value for an appropriate dimension of DHT 115. Further information about the implementation of Holochains and the action of distributed applications as agents on a Holochain is available in U.S. Pat. No. 10,951,697, titled “Holochain—A Framework For Distributed Applications,” which is included herein in its entirety.

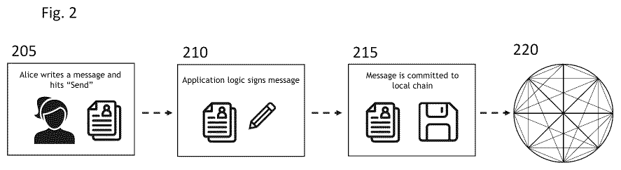

FIG. 2 shows part of the operation of one exemplary agent in a Holochain application. In FIG. 2, a participant (“Alice”) using an application defined over Holochain 100 creates an event by interacting with a node 105 running Application Logic 110. In one embodiment, node 105 is running on a computing device such as a laptop, server, or mobile phone. Alice interacts with the Application 100, for example, by writing a message (i.e., data) for sharing with other nodes of Application 100 (block 205). Alice cryptographically signs the message with public-key encryption (block 210). The message, with Alice's signature, may be saved (or committed) locally at Alice's private space (block 215). The data, such as the message, plus Alice's signature, is placed into the DHT after local validation (block 220). In similar fashion, other occurrences, messages, or updates may be similarly created by or at an agent, with or without the interaction of a human participant. In various embodiments, one or more of these are an event as discussed previously.

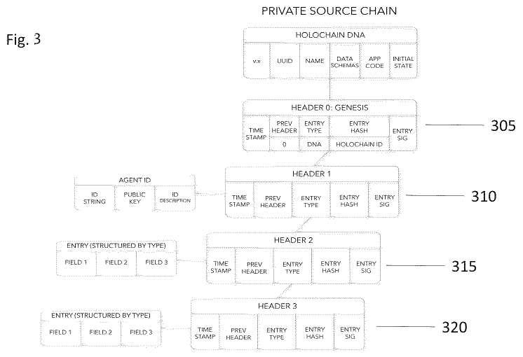

FIG. 3 shows an exemplary structure of a source chain 112 corresponding to Application 100 according to one embodiment. In FIG. 3, local source chain 112 includes blocks 305-320, where 305 indicates the root (or “genesis”) of the source chain. The root of the source chain may include additional information, stored in various fields in various embodiments. For example, block 305 may comprise header0, which includes a timestamp (indicating the time when 305 is created or a similar “starting” time), an entry hash (e.g., the root), an entry type (e.g., addition, deletion or modification of the data), an entry signature (e.g., the signature of the node creating block 305), a previous header (e.g., the previous block hash), a Holochain ID, and the state modification rules applying to the Application (the Application “DNA”). Header0 may be hashed to create a block hash or an identifier of block 305. As subsequent events are stored in the source chain, additional records 310, 315 and 320 are added to the source chain 112. Each of these events include a header and data. As described, the header of each block 305-320 may include one or more fields with metadata, including a timestamp associated with the event. In this embodiment, each event has a location in space, where the location is the same as the agent creating the record. This embodiment also has a location in time, where the origin of the time ray is given by the timestamp at the root of the source chain, and each event's time coordinate is found by looking at the timestamp associated with the event record. The further metadata fields can be used to store other arbitrary dimensions by which the event can be indexed in the DHT, or alternatively, as inputs to equations for which the output can be used as a dimensional coordinate.

The embodiment shown in FIG. 3 shows a source chain, where each record in the ledger has a single parent and a single child going back to the root. In another embodiment, the source chain may be better characterized as a tree or graph, especially a directed acyclic graph (“DAG”). In an embodiment where the source chain is best characterized a DAG (i.e. a “source DAG”), updates to one leaf vertex of the graph does not depend upon all other branches in the tree to be finalized or committed—only the vertices in the path from the parent(s) of the new vertex back to the root need to be final. Because each agent has its own hash, the branching factor can be potentially as high as the number of agents participating in the Holochain, so that the path leading back to the root can be correspondingly short. The edges in the source DAG are directed edges with the direction always heading away from the root. However, different embodiments can assign different meanings to the directional edges. In one embodiment, the directional edges are causal. In another embodiment, the direction of the edges are defined by increasing time as measured by the timestamp. Further embodiments use measurements corresponding to other quantities, such as a distance measurement (e.g. kilometers from the location of the root), network distance (e.g. number of network hops from a set interface), or latency. Some embodiments assign a compound meaning to the edges, such as (time, causality).

For purposes of the DHT 115, many different agents need to share information about events so that the source chains can coordinate their separate understanding of the state of the Holochain 100. The agents gossip between themselves to communicate events and other updates between the different nodes hosting agents operating on Holochain 100. In some embodiments, the system enforces synchronous communication so that all participating nodes participate in transactions so that each has the same “committed” version of the source chain, even if different nodes each have open transactions that pertain to uncommitted events. In synchronous embodiments, each transaction can be associated with a communication round. In another embodiment, changes are associated transactionally. When communicating a state change to multiple chains, they all end up with the same timestamp, and should all fail or all succeed as part of a logical transaction. In other embodiments, the Holochain uses an eventually consistent model, where each participating node communicates about updates on its own schedule, either as events occur or in batches. In one embodiment using an eventually consistent model, a rule specifies when to consider part of the chain fully committed. In one embodiment, all participants in the DHT register their interest in the source chain when they first join or participate in the DHT. In this embodiment, a vertex in the source chain is not considered final until all previously registered agents have acknowledged an update. In another embodiment, a quorum of agents needs to acknowledge the update for it to be considered committed. In a further embodiment, the timestamp can be used to define an “active” phase and a “quiet” phase, where any record in the ledger that has a timestamp before a particular time is quieted and is accepted as final.

In some embodiments, all records that pass beyond the quieting threshold are fixed, so the scope of the multi-dimensional DHT can change to exclude changes within the quieted portion of the DHT space. This reduces the size of the information that needs to be coordinated and can lead to greater efficiency.

For a Holochain with a source DAG, not all the changes to the DAG need be accepted before committing a message at a leaf vertex. Only the vertices on the path to the root (for a tree) or on all paths from a new vertex to the root (for a DAG) need to be accepted. The accepted state of previous vertices can be calculated in different ways by different embodiments. In one embodiment, the previous vertices can be “committed” as previously described. However, another embodiment does not require agreement about the committed nature of a particular vertex message, as long as the proposed vertices later in the chain can each independently cryptographically verify the events in the ledger leading back to the root.

In one embodiment that removes the need for consensus or fixation, the agents instead substitute the ability for each new agent to validate the path(s) back to the root quickly and independently. In one implementation, this no-fixation embodiment uses a value or calculation fixed in the root vertex that, when used with or applied to the location (or locations) of the event identified in the vertex record, can be used to record and identify any children of a vertex of the source DAG. Because all agents participating in a Holochain are aware of this “next” location, the information in an event can be verified by checking that the parent vertex/vertices of the next proposed vertex are themselves leaf vertices. An agent can enforce Application rules, such as “only leaf vertices can add new information to the DAG” by refusing to create a new vertex if the proposed parent vertex in the source DAG is not itself a leaf, and if all other links in the source DAG can themselves be verified. A further embodiment loosens the “only leaf vertex” restriction by conducting extended verification of all child vertices to make sure that no inconsistent updates are applied (e.g. “double spends”). Another embodiment improves efficiency by, for example, imposing the restriction that all interactions between agents be recorded as either solitary (single parent, single child) or pairwise (two parents, single child) events, thus preventing a combinatorial explosion of possible verification paths.

In a Holochain network such as any of the embodiments described above, each node is in communication with a subset of the other nodes in the network, but as the number of nodes increases, it becomes impractical for each node to be connected with all or even a substantial portion of the available nodes. The nodes need to coordinate with each other to perform updates, to store or retrieve records, or to validate records stored in the distributed ledger. In one embodiment, the Holochain network may use a QDHT to organize and find the other participants in the distributed ledger. Unless specified otherwise below, the embodiments and implementations discussed are using a spacetime QDHT as the DHT below, so that various operations and advantages corresponding to different embodiments can be better described.

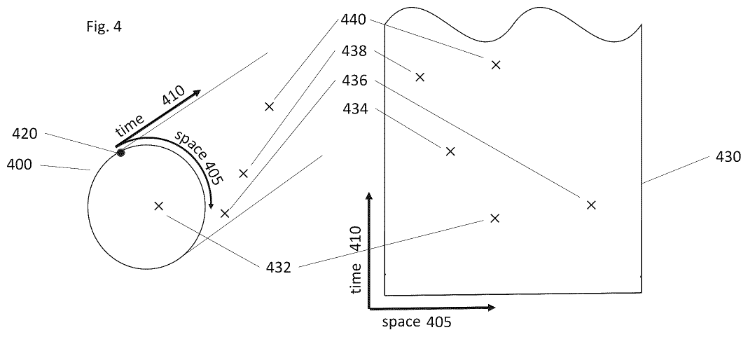

Turning now to FIG. 4, the exemplary spacetime DHT is topologically represented as cylinder 400, with the space axis 405 wrapping around itself, and time axis 410 extending along its length, with the base fixed at the root of the network 420 (as set by the timestamp in the root vertex of the ledger), and the other circular edge forever extending into the future. All events and operations have multidimensional addresses that correspond to somewhere on this cylinder or can be said to “exist” somewhere on this cylinder. As discussed previously, various embodiments of the QDHT may have an arbitrary number of dimensions, some of which are closed (like the space dimension in the spacetime QDHT) or open (like the time dimension in the spacetime QDHT).

For the purposes of describing various embodiments, it helps to unravel the cylinder into plane 430, but this is for ease of explanation only. Markings 432-440 show where events or operations recorded in the DHT are located in space and time. An agent's DHT arc is defined by a space interval, which describes a lengthwise strip on the cylinder, or a vertical strip of spacetime possibly represented as two adjacent strips if the arc spans the origin). Thus, the agent's arc describes a large rectangular region of spacetime.

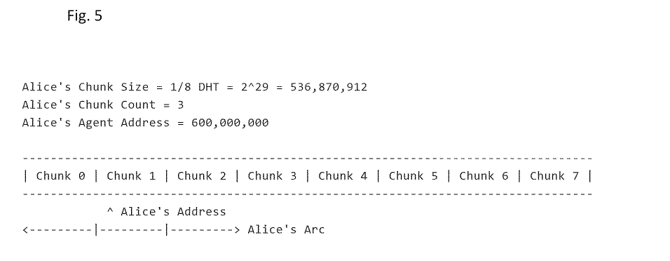

Referring now to FIG. 5, a representation of the chunks, chunk offsets, and arc values is shown. In one embodiment of the QDHT each node represents their arc for a given DHT as a chunk size and chunk count. An agent starts each chunk at an integer multiple of the chunk size, rather than at an offset from the agent address, so that they will match those of other agents. For ease of division, this embodiment has chunk sizes equal to one of the powers of two smaller than or equal to the number of total DHT addresses, rather than a continuous range. In an embodiment with 2³² total DHT addresses, nodes can represent their chunk size as simply an exponent between 0 and 32. For example, representing a chunk as a 32 means that the chunk is the whole DHT, a 31-chunk is half the DHT, and so forth, down to a 0-chunk, which is equal to the quantum size.

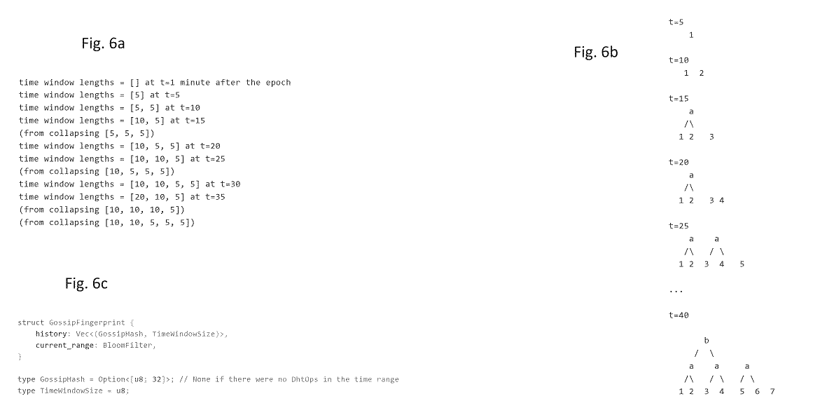

Referring to FIGS. 6a, 6b, and 6c, representations of the time field are shown. The time dimension of the spacetime field can be similarly divided, although adjustments are needed because the time dimension is not closed. In one embodiment, the time chunk size is equal to a power of two times a constant, such as five minutes. In this embodiment the time window can be represented as an exponent, similar to the space dimension. Other embodiments use different methods of dividing the time ray. In one embodiment, the time from the epoch until the current moment can be divided in half, rounding down at the closest year so that there is a little bit more in the “closer” half. This can be further subdivided into months, weeks, days, and so on. In another embodiment, the time dimension is built up from the chunk size. For example, if a chunk is one minute (60 seconds), then the largest exponent of the chunk size is used as the divisor. In this case, 60¹=1 minute; 60²=3600 seconds, or one hour; 60³=216,000 seconds, or 60 hours; 60⁴=12,960,000 seconds, or about 150 days, and so on.

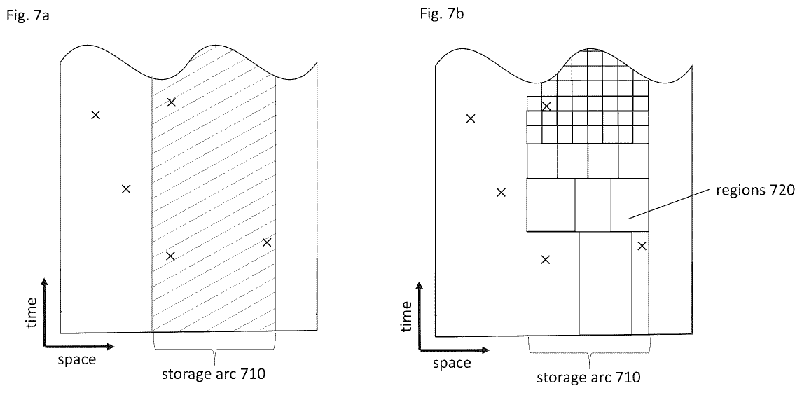

Looking at FIG. 6-3, a code representation of the time hash is shown according to one embodiment. In this embodiment, time is chunked as a power of a given number of seconds times the constant equal to five minutes. When gossiping about a given chunk, this embodiment uses a hash-based representation of the events in the range that has higher granularity for recent data and gradually lower time granularity for older, more stable data. For time data, this embodiment uses a vector of historical hashes (the “fingerprint” of this time period), each associated with a time range, as well as a record of events associated with the current time range, here implemented as a bloom/vacuum filter. The current range contains the hashes of the events in the range with timestamps from the last 5 minutes. At the end of each 5 minute period, the agent resets current range to be empty and append an item to its history, with a hash determined by querying the database for all the events in that time range, sorting them by timestamp, concatenating their hashes into a vector, and applying a further hash, such as Blake, to the bytes. Once there are three history items with the same time window size, the agent collapses the older two of them into one history item with twice the time window size and with a hash equal to a linear or bytewise combination of the two subsidiary fingerprint hashes, such as by using XOR. This way, a time window N minutes long ends at least N−5 minutes ago. In various embodiments it is useful to use a sparse tree representation for historical data so that time periods with no data have NULL values. This allows periods with no events to be represented cheaply and the record doesn't need to be traversed more deeply to know they're empty. In an embodiment using the XOR function as a combinator for the subsidiary fingerprint hashes, this allows the important information (where information actually exists) to persist upward in the tree as far as possible. Turning now to FIGS. 7a and 7b, a method of optimizing the calculation and coordination of state messages about the source chain is provided according to one embodiment. When two agents need to coordinate state changes, they gossip between themselves. In one embodiment, an agent finds the rectangle in spacetime specified by its arc (shown as storage arc 710) and partitions it into a number of rectangles of varying sizes (shown as regions 720). It then takes the hash of each rectangle which is a combination of all the hashes of all of the events contained in that region. Call this hash the “fingerprint” of a region. The agent sends the fingerprints, optionally along with some extra data like the total size of the events contained in each region, to its gossip partner, and receives the same from the other agent. The agent then compares the collection of fingerprints sent by the other agent to the locally stored values. In this embodiment, it is not necessary for the compared region shapes in spacetime to be the same size or same shape. If the difference is too large, the agent asks its partner to send fingerprints of smaller regions for the mismatched areas, and repeats until the difference is small enough or it can be determined that there is no feasible way to reduce the difference. Once the reduction has terminated, the selected events within the region are individually gossiped to the partner.

In order to efficiently compute and lookup hashes of arbitrary regions of spacetime, a suitable data structure is needed. In one embodiment, multidimensional Fenwick trees over the XOR operator are a useful structure for accomplishing this process. A Fenwick tree is typically used to compute a cumulative sum over an array of values, starting from index 0. It can be extended to higher dimensions, computing cumulative sums over areas and volumes starting at index 0. This can be used to compute the sum of any arbitrary region by a linear combination of cumulative sums. For instance, sum(20, 30) is equal to sum(0, 30)−sum(0, 19).

In one embodiment this is used to efficiently compare regions of spacetime given their fingerprints. By using a specially constructed “cumulative XOR” tree, an agent can compute the XOR fingerprint of arbitrary regions of spacetime by taking the XOR of the largest region (all regions begin at (0, 0)) and then XOR the extraneous regions to remove them from the picture, leaving the XOR of the bounded region as needed. In 2D, every region calculation involves 4 queries, where the largest region hash is XOR'd with the smaller 3 contained within it. This is similar in effect to a Merkle tree, but with the benefit of left-right associativity and fast computation.

One benefit associated with embodiments using the quantization rules as described is that two regions that need to be compared will always have an integer offset n that aligns the edge of the two regions. In multidimensional space, a second offset m will do the same for the next dimension up, and so forth. Therefore when comparing arcs or regions between two agents, there either be zero overlap (which is easily identifiable by looking at the values provided) or it will have an integer multiple of quantum-sized regions that should exactly overlap, thus allowing efficient comparison and synchronization.

Those of skill in the art will notice the use of the XOR function in some embodiments to quickly identify regions that have different data requiring synchronization. In some embodiments it is useful to use a comparison function that is associative, so that the comparison of region 1 and region 2 is comparable or equal to the comparison of region 2 with region 1, which is true for XOR. Other embodiments can use different functions, including probabilistic functions, order-independent hashes, or other comparison functions.

It is further recognized that the XOR function provides no security guarantees. However, for many embodiments no security guarantees are necessary for the spacetime region comparison operation. The use of XORs are used to judge whether two regions should be fully reconciled by gossiping all of the events contained therein. The reconciliation process is based upon the verification of each link in the source chain, which is cryptographically secure. For embodiments that wish to minimize the chance of collisions while still using XOR, there are a number of ways to assure that outcome.

In one embodiment, an agent can periodically reshuffle all the hashes by including some nonce. An agent can either include the nonce into each hash before an agent XOR, or an agent can simply make the “zero” value of each node the hash of a nonce rather than all zeroes. The nonce can be time-based, based on broad periods of time measured starting from the genesis epoch, for instance once every 24 hours. When nodes are gossiping, they advertise what nonce they are using, either explicitly in the initial handshake, or implicitly via the max timestamp of the events they are sharing. If the nonces do not match, this can imply aberrant node behavior or an edge condition where an agent is close to the time boundary and one node has crossed over and the other hasn't. In both cases, the nodes can simply decline to gossip with each other, knowing that if both are trustworthy, soon both nodes will have compatible nonces and will be able to compare their regions. If a node has an error or has been subverted to act maliciously, then the mismatched nonces will prevent comparisons until at least that aspect of the aberrant node is updated.

Those of skill in the art will also note that the XOR function is being used in a different way in this region comparison than it is being used, for example, in the Kademlia DHT. In Kademlia, the distance between any two nodes is the XOR of the node addresses, giving a dimensionaless measurement that still conforms to the triangle inequality. Using an XOR function for comparisons between node addresses is compatible with but not required for QDHT; a DHT using Kademlia-style addressing could use QDHT-style quantization and comparison rules independently.

Referring now to the quantization rules for the QDHT, the quantum size determines the finest level of granularity an agent can use to express DHT arcs and regions for gossip. In embodiments that use binary trees to derive subdivisions of spacetime, the quantum size also determines the size of every larger subdivision above a single quantum, because each arc or region is sized to be an exponential multiple of the quantum length.

When choosing a quantum size for a given dimension, they are related by the following equation:

$$\begin{matrix}Q \cdot {b}^{D} = M \\ b = {( \frac{M}{Q} )}^{\frac{1}{D}}\end{matrix}$$

where the parameters are as follows:
Q is the quantum length, or smallest possible value
M is the maximum value representable
D is the bit depth, or number of bits used to represent levels between the min and max value.

Various embodiments can start from any parameter and compute the others accordingly. For example, in an embodiment where the time quantum is 5 minutes, an implementor may want to be able to represent up to 10 years (315567360 minutes) of future data from the moment of network creation. With 32 bits of resolution, that provides the following:

$$b = {( \frac{315567360}{5} )}^{\frac{1}{32}} = 1.7529$$

In this embodiment of the time dimension, each larger region is not actually a multiple of 2, but of about 1.75. Other embodiments can approach this in other ways, like fixing b and Q and deriving the other values.

To provide another exemplary example for the space dimension, the effects of choosing a space with bit depth D=32:

Q=2⁴→b≈1.83

Q=2⁸→b≈1.68

Q=2¹²→b≈1.54

Q=2¹⁶→b≈1.41

As the space quantum goes up, the “closer” together the 32 subdivisions of space become. In another embodiment, an implementor can choose to fix b=2, and save on bytes instead. For example, if Q=2^{q} then D=32−q.

For flexibility, an implementer setting the parameters for a spacetime region can choose values for the space quantum, the space bit depth, the time quantum, the time bit depth, and the maximum time in the future to support. It is straightforward to extend these to higher dimensions as previously discussed.

For embodiments using a Fenwick tree, each level in the Fenwick tree corresponds to successive layers of subdivision of spacetime. Every layer of depth down the tree splits spacetime in half, either along the space or time dimension. So, the more specific an agent wants to be about its regions, the more nodes an agent has to store and compute in the tree.

Experimentally, an agent that wants to store arbitrary regions all the way down to the precision of 2³² will need to store approximately 200 tree nodes for every event the agent wants to add. This can use a substantial amount of memory and it may be unnecessary for some embodiments to have that level of detail. However, various embodiments can tune their depth of interest. Sparse Fenwick trees only need deep nodes to describe finer subdivisions of space, and sparse trees only create nodes that are needed, so if an agent only needs to refer to regions to a certain level of quantization, the tree is guaranteed to only grow to a certain depth. Further, in an embodiment where an agent doesn't need to talk about regions above a certain size, agents can be configured to disallow the tree from storing nodes shallower than a certain level. By bounding the depth of nodes an agent will store from both above and below, an agent can achieve a reasonable memory overhead.

Turning attention to choosing time and space intervals for regions, various embodiments have different methods of splitting up a spacetime rectangle into smaller rectangles. A general principle usable in many embodiments is that the time interval an agent chooses for a given region should be inversely proportional to the probability of encountering new events within that region during a gossip round. In the time dimension, one embodiment uses larger intervals for older times, because it is expected that older data will change less often than recent data. This allows agents to send fingerprints that cover wide swaths of time and ask for more precise fingerprints in the rare case that an agent encounters a mismatch. As the probability of unmatched data decreases over time, older regions grow longer in time. In some embodiments, the probability of change can also be a factor for recent data. If a network sees a surge in activity, the time window for recent data can be decreased, or inversely, increased during a lull. Either way, in many embodiments the time window for older data will increase as more time passes.

With reference to space intervals, the general principle is that the space interval for a given region should be chosen based on the density of data in that region. The definition of density can vary from embodiment to embodiment. In one embodiment, a density measurement might correspond to the size, in bytes, of all events in a region. Even though any number of events can be represented by a single 32 byte XOR fingerprint, the cost of a fingerprint mismatch is higher for regions with more data. Either the entirety of data in that region must be sent, or another roundtrip must be completed to exchange more detailed fingerprints to reduce the size of the regions compared.

In some embodiments it may be useful to include information about the number of events in a region in the calculation of region size. Various embodiments can use that as a hint as to whether it is useful to do the work of splitting the region into smaller pieces, which may involve a gossip roundtrip. A region with a large number of events is more likely to be evenly splittable, whereas a region with a small number of events is less likely to be splittable. A region with only one event is unsplittable.

In an embodiment where one of the goals is to assure complete coverage of the range across all currently participating nodes, another factor in choosing space intervals is that the storage arc must be completely covered in the space dimension by the selection of fingerprints. In this embodiment the arc size needs to be selected based on the density of data within it, especially around the edges.

A factor in some embodiments is the selection of arc size in a particular dimension, especially for embodiments where there are constraints such as ensuring full coverage of the entire spacetime field. In a static network the arc size can be determined beforehand. But in the more common dynamic case, adding or removing participating nodes will result in the readjustment of agent arcs. When an agent grows or shrinks its arc, it can expect R peers to do the same. Therefore, it is possible to calculate the gain or loss in coverage due to the change as:

$$Δ {c}_{o} ( a ) = \frac{c ( a ) \cdot \vert a \vert}{l + \vert a \vert} = \frac{q \cdot c ( a )}{n q} = \frac{c ( a )}{n}$$

where n and q are the values after the change.

An optimal partition is one for which the expected data sent is the same across all regions. This is difficult to achieve but it is possible to get close. This is the optimum because if there is a “hotspot” region which is causing disproportionately more bandwidth to be used versus other regions, it would be better that the hot region had been split into smaller regions so there would be a greater chance of avoiding an update in one of the smaller regions. Likewise, a “cold” region would have been better consolidated to save on the overhead of transmitting data about the extra region. The theoretical optimum is when the overhead of region data equals expected event data.

This objective is tempered by the discrete nature of the QDHT. In general, splitting a large region into smaller regions will result in less total data being sent, but this is only true when the region contains many events, and the probability declines as the number of events in the region falls. When evaluating a space region, it may not be possible to identify a density function if the associated hash is a perfect hash, but perfect hashes are not necessary for QDHT. In one embodiment, a locality-preserving hash groups “similar” events near each other. While the anterior probability of an event being in any particular region is equal, observation will allow the system to identify current hot spots and apply a decaying probability that the hot spots will stay hot, thus allowing for proactive resizing of the arcs over time.

With reference to time dimensions, the probability of having changes in a region, p(r), is approximated as a function of its coordinates in time: it has nothing to do with the actual data present in spacetime. Consider a continuous function across all of spacetime, which starts at 1 for the present moment, and exponentially decreases as we go back to the beginning of time. The probability of a region then is the integral of this continuous underlying probability density, bounded by the region.

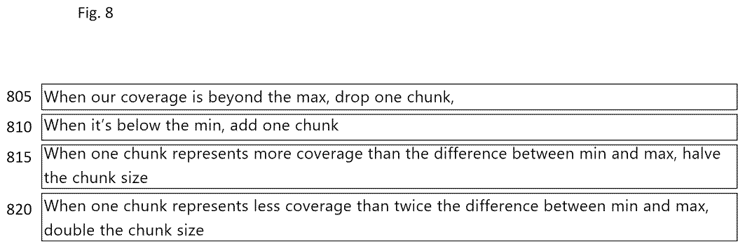

Turning now to FIG. 8, the quantization of the arc has a relationship to the error in coverage, or overshoot. In various embodiments it is helpful to allow a range of coverage targets, the lower bound of which is the actual ideal coverage, up to a maximum of some buffer on top of the ideal. The quantization chosen forces either overshoot or undershoot of the target, so it is possible to pick a such that each chunk is small enough to represent less than the width of the target coverage range. This allows an embodiment to use a resizing or requantizing algorithm as shown in 8. At 805, when our coverage is beyond the maximum, drop one chunk. At 810, when coverage is below the minimum, add one chunk. At 815, when one chunk represents more coverage than the difference between min and max, halve the chunk size. At 820, when one chunk represents less coverage than twice the difference between min and max, double the chunk size.

As described, it is possible to determine the maximum quantization resolution (a minimum “chunk size”) for representing an arc, based solely on the estimated coverage in the arc. If:
cₜ is the minimum coverage to uphold in the network
c₀ is the observed average coverage within an agent's arc
b is a “buffer” which sets the maximum coverage at cₜ (b+1), e.g. if cₜ=50 and b=0.1, then the maximum coverage is 55.
n is the number of chunks you use to compute your arc, assuming that all chunks are the same size
q is of the form 1/(2ⁿ) and represents a proportion of the entire DHT space.
l is the absolute length of your arc so that l=nq
   Then the amount of coverage represented by any arc (or chunk) is given by c(a), where a describes the bounds of the arc. It may be different for every arc at any given time.

In various embodiments, it may be helpful to set chunks to be as large as possible such that dropping or adding one to an agent's arc still keeps the system within the target coverage range. In that case the overall change to coverage by adding a new chunk a is given by:

$$Δ {c}_{o} ( a ) = \frac{c ( a )}{n}$$

In this case the constraint is that Δc₀(a)<cₜ(b) so that the change from adding a single chunk should be less than the buffer range there is no overshoot. In that case:

$$\begin{matrix}\frac{c ( a )}{n} < {c}_{t} b \\ n > \frac{c ( a )}{{c}_{t} b}\end{matrix}$$

Under normal circumstances, this results in cₜ≤c(a)≤cₜ(b+1) for any a, and beyond those points is when it is desirable to either grow or shrink, respectively. Writing both cases:

$$n > \{ \begin{matrix}\frac{1}{b} & when growing \\ \frac{b + 1}{b} & when shrinking\end{matrix}$$

The shrinking case is always larger, so the operative value is:

$$n > \frac{b + 1}{b}$$

This is representative of a minimum number of chunks for the system, so instead of reducing the number of chunks it is preferable to decrease the quantum size q so that each chunk is smaller. Solving for b provides an expression for the buffering amount provided in this embodiment:

$$b = \frac{1}{n - 1}$$

So, for example, a min chunk count of n=8 affords a buffer of 1/7, ≈14.3%.

Referring now to FIG. 9, diagram 900 shows an information processing system 910 which may function as a node, coupled to a network 905. The network 905 could be any type of network, for example, wired network, wireless network, a private network, a public network, a local area network (LAN), a wide area network (WAN), a wide local area network (WLAN), a combination of the above, or the like. The network may also be a virtual network, such as an overlay or underlay network. In some embodiments, the network may operate on more than one level such that connections between nodes are virtually addressed or content addressed. An information processing system is an electronic device capable of processing, executing or otherwise handling information. Examples of information processing systems include a server computer, a personal computer (e.g., a desktop computer or a portable computer such as, for example, a laptop computer), a handheld computer, and/or a variety of other information handling systems known in the art. The information processing system 910 shown is representative of, one of, or a portion of, the information processing systems described above.

The information processing system 910 may include any or all of the following: (a) a processor 912 for executing and otherwise processing instructions, (b) one or more network interfaces 914 (e.g., circuitry) for communicating between the processor 912 and other devices, those other devices possibly located across the network 905; (c) a memory device 916 (e.g., FLASH memory, a random access memory (RAM) device or a read-only memory (ROM) device for storing information (e.g., instructions executed by processor 912 and data operated upon by processor 912 in response to such instructions)). In some embodiments, the information processing system 910 may also include a separate computer-readable medium 918 operably coupled to the processor 912 for storing information and instructions as described further below.

In one embodiment, there is more than one network interface 914, so that the multiple network interfaces can be used to separately route management, production, and other traffic. In one exemplary embodiment, an information processing system has a “management” interface at 1 GB/s, a “production” interface at 10 GB/s, and may have additional interfaces for channel bonding, high availability, or performance. An information processing device configured as a processing or routing node may also have an additional interface dedicated to public Internet traffic, and specific circuitry or resources necessary to act as a VLAN trunk.

In some embodiments, the information processing system 910 may include a plurality of input/output devices 920a-n which are operably coupled to the processor 912, for inputting or outputting information, such as a display device 920a, a print device 920b, or other electronic circuitry 920c-n for performing other operations of the information processing system 910 known in the art.

With reference to the computer-readable media, including both memory device 916 and secondary computer-readable medium 918, the computer-readable media and the processor 912 are structurally and functionally interrelated with one another as described below in further detail, and information processing system of the illustrative embodiment is structurally and functionally interrelated with a respective computer-readable medium similar to the manner in which the processor 912 is structurally and functionally interrelated with the computer-readable media 916 and 918. As discussed above, the computer-readable media may be implemented using a hard disk drive, a memory device, and/or a variety of other computer-readable media known in the art, and when including functional descriptive material, data structures are created that define structural and functional interrelationships between such data structures and the computer-readable media (and other aspects of the system 900). Such interrelationships permit the data structures' functionality to be realized. For example, in one embodiment the processor 912 reads (e.g., accesses or copies) such functional descriptive material from the network interface 914, the computer-readable media 918 onto the memory device 916 of the information processing system 910, and the information processing system 910 (more particularly, the processor 912) performs its operations, as described elsewhere herein, in response to such material stored in the memory device of the information processing system 910. In addition to reading such functional descriptive material from the computer-readable medium 918, the processor 912 is capable of reading such functional descriptive material from (or through) the network 905. In one embodiment, the information processing system 910 includes at least one type of computer-readable media that is non-transitory. For explanatory purposes below, singular forms such as “computer-readable medium,” “memory,” and “disk” are used, but it is intended that these may refer to all or any portion of the computer-readable media available in or to a particular information processing system 910, without limiting them to a specific location or implementation.

The information processing system 910 may include a container manager 930. The container manager is a software or hardware construct that allows independent operating environments to coexist on a single platform. In one embodiment, the container manager is a hypervisor. In another embodiment, the container manager is a software isolation mechanism such as Linux cgroups, Solaris Zones, or similar. The container manager 930 may be implemented in software, as a subsidiary information processing system, or in a tailored electrical circuit or as software instructions to be used in conjunction with a processor to create a hardware-software combination that implements the specific functionality described herein. To the extent that software is used to implement the hypervisor, it may include software that is stored on a computer-readable medium, including the computer-readable medium 918. The container manager may be included logically “below” a host operating system, as a host itself, as part of a larger host operating system, or as a program or process running “above” or “on top of” a host operating system. Examples of container managers include Xenserver, KVM, VMware, Microsoft's Hyper-V, and emulation programs such as QEMU, as well as software isolation mechanisms such as jails, Solaris zones, and Docker containers.

The container manager 930 includes the functionality to add, remove, and modify a number of logical containers 932a-n associated with the container manager. Zero, one, or many of the logical containers 932a-n contain associated operating environments 934a-n. The logical containers 932a-n can implement various interfaces depending upon the desired characteristics of the operating environment. In one embodiment, a logical container 932 implements a hardware-like interface, such that the associated operating environment 934 appears to be running on or within an information processing system such as the information processing system 910. For example, one embodiment of a logical container 934 could implement an interface resembling an x86, x86-64, ARM, or other computer instruction set with appropriate RAM, busses, disks, and network devices. A corresponding operating environment 934 for this embodiment could be an operating system such as Microsoft Windows, Linux, Linux-Android, or Mac OS X. In another embodiment, a logical container 932 implements an operating system-like interface, such that the associated operating environment 934 appears to be running on or within an operating system. For example one embodiment of this type of logical container 932 could appear to be a Microsoft Windows, Linux, or Mac OS X operating system. Another possible operating system includes an Android operating system, which includes significant runtime functionality on top of a lower-level kernel. A corresponding operating environment 934 could enforce separation between users and processes such that each process or group of processes appeared to have sole access to the resources of the operating system. In a third environment, a logical container 932 implements a software-defined interface, such a language runtime or logical process that the associated operating environment 934 can use to run and interact with its environment. For example one embodiment of this type of logical container 932 could appear to be a Java, Dalvik, Lua, Python, or other language virtual machine. A corresponding operating environment 934 would use the built-in threading, processing, and code loading capabilities to load and run code. Adding, removing, or modifying a logical container 932 may or may not also involve adding, removing, or modifying an associated operating environment 934.

In one or more embodiments, a logical container has one or more network interfaces 936. The network interfaces (NIs) 936 may be associated with a switch at either the container manager or container level. The NI 236 logically couples the operating environment 934 to the network, and allows the logical containers to send and receive network traffic. In one embodiment, the physical network interface card 914 is also coupled to one or more logical containers through a switch.

In one or more embodiments, each logical container includes identification data for use naming, interacting, or referring to the logical container. This can include the Media Access Control (MAC) address, the Internet Protocol (IP) address, and one or more unambiguous names or identifiers.

In one or more embodiments, a “volume” is a detachable block storage device. In some embodiments, a particular volume can only be attached to one instance at a time, whereas in other embodiments a volume works like a Storage Area Network (SAN) so that it can be concurrently accessed by multiple devices. Volumes can be attached to either a particular information processing device or a particular virtual machine, so they are or appear to be local to that machine. Further, a volume attached to one information processing device or VM can be exported over the network to share access with other instances using common file sharing protocols. In other embodiments, there are areas of storage declared to be “local storage.” Typically a local storage volume will be storage from the information processing device shared with or exposed to one or more operating environments on the information processing device. Local storage is guaranteed to exist only for the duration of the operating environment; recreating the operating environment may or may not remove or erase any local storage associated with that operating environment.

In a distributed system involving multiple nodes, each node will be an information processing system 910 as described above in FIG. 9. The information processing systems in the distributed system are connected via a communication medium, typically implemented using a known network protocol such as Ethernet, Fibre Channel, Infiniband, or IEEE 1394. It can be implemented on an overlay or underlay network as required by a specific application. The distributed system may also include one or more network routing elements, implemented as hardware, as software running on hardware, or may be implemented completely as software. In one implementation, the network routing element is implemented in a logical container 932 using an operating environment 934 as described above. In another embodiment, the network routing element is implemented so that the distributed system corresponds to a group of physically co-located information processing systems, such as in a rack, row, or group of physical machines.

The network routing element allows the information processing systems 910, the logical containers 932 and the operating environments 934 to be connected together in a network topology. The illustrated tree topology is only one possible topology; the information processing systems and operating environments can be logically arrayed in a ring, in a star, in a graph, or in multiple logical arrangements through the use of vLANs.

In one embodiment, one or more nodes acts as a controller to administer the distributed system. The controller is used to store or provide identifying information associated with the different addressable elements in the distributed system—specifically the cluster network router (addressable as the network routing element), each information processing system 910, and with each information processing system the associated logical containers 932 and operating environments 934.

The various embodiments described above are provided by way of illustration only and should not be constructed to limit the scope of the disclosure. Various modifications and changes can be made to the principles and embodiments herein without departing from the scope of the disclosure and without departing from the scope of the claims.

What is claimed is:

1. A system for coordinating distributed computation, the system comprising:
a plurality of nodes, each node including a processing element, a network interface, and a memory, the plurality of nodes communicatively coupled together via a network;
a keyspace defined across the plurality of nodes, the keyspace having at least two discretized dimensions;
wherein each node of the plurality of nodes is associated with a region of the keyspace, wherein at least one dimension of the region corresponds to a closed dimension of the keyspace using a hash function mapping inputs to points in the keyspace;
and wherein a first node of the plurality of nodes and a second node of the plurality of nodes are configured to coordinate stored state by:
at the first node, computing a first cryptographic fingerprint of the data associated with a region of the keyspace to coordinate (the “coordination region”);
at the second node, computing a second cryptographic fingerprint of the data associated with the coordination region;
comparing the first cryptographic fingerprint and the second cryptographic fingerprint; and
when the first cryptographic fingerprint is different than the second cryptographic fingerprint, communicating a state change message to synchronize the state between the first node and the second node.

2. The system of claim 1 wherein at least one dimension of the region is a temporal dimension.

3. The system of claim 1 wherein at least one dimension of the region is defined by a logical clock.

4. The system of claim 1 wherein the state change message updates stored state that is temporally or logically older using information that is temporally or logically newer.

5. The system of claim 1 wherein the first node of the plurality of nodes and a second node of the plurality of nodes are further configured to coordinate stored state by:
when the first cryptographic fingerprint is different than the second cryptographic fingerprint, partitioning the region into a first sub-region and a second sub-region; and iteratively using the first sub-region and the second sub-region as the coordination region.

6. The system of claim 5 wherein the partitioning and comparing of the coordination region between the first node and the second node is performed recursively until at least one dimension of the coordination region reaches the smallest discrete size allowed in that dimension.

7. The system of claim 2 wherein the dimensions of the coordination region are chosen so that they are larger in the temporal dimension for older values and smaller in the temporal dimension for newer values.

8. A method for coordinating distributed computation, the method comprising:
defining a keyspace defined across a plurality of nodes, the keyspace having at least two discretized dimensions;
associating each node of the plurality of nodes is associated with a region of the keyspace, wherein at least one dimension of the region corresponds to a closed dimension of the keyspace using a hash function mapping inputs to points in the keyspace;
coordinating state information between a first node of the plurality of nodes and a second node of the plurality of nodes by:
at the first node, computing a first cryptographic fingerprint of the data associated with a region of the keyspace to coordinate (the “coordination region”);
at the second node, computing a second cryptographic fingerprint of the data associated with the coordination region;
comparing the first cryptographic fingerprint and the second cryptographic fingerprint; and
when the first cryptographic fingerprint is different than the second cryptographic fingerprint, communicating a state change message to synchronize the state between the first node and the second node.

9. The method of claim 8 wherein at least one dimension of the region is a temporal dimension.

10. The method of claim 8 wherein at least one dimension of the region is defined by a logical clock.

11. The method of claim 8 wherein the state change message updates stored state that is temporally or logically older using information that is temporally or logically newer.

12. The method of claim 8 wherein the first node of the plurality of nodes and a second node of the plurality of nodes are further configured to coordinate stored state by:
when the first cryptographic fingerprint is different than the second cryptographic fingerprint, partitioning the region into a first sub-region and a second sub-region; and iteratively using the first sub-region and the second sub-region as the coordination region.

13. The method of claim 12 wherein the partitioning and comparing of the coordination region between the first node and the second node is performed recursively until at least one dimension of the coordination region reaches the smallest discrete size allowed in that dimension.

14. The method of claim 9 wherein the dimensions of the coordination region are chosen so that they are larger in the temporal dimension for older values and smaller in the temporal dimension for newer values.

15. Instructions encoded in one or more tangible media for execution on one or more processors located on a plurality of nodes, each of which includes a processor and a memory, which when executed cause one or more nodes of the plurality of nodes to perform operations comprising:
defining a keyspace defined across the plurality of nodes, the keyspace having at least two discretized dimensions;
associating each node of the plurality of nodes is associated with a region of the keyspace, wherein at least one dimension of the region corresponds to a closed dimension of the keyspace using a hash function mapping inputs to points in the keyspace;
coordinating state information between a first node of the plurality of nodes and a second node of the plurality of nodes by:
at the first node, computing a first cryptographic fingerprint of the data associated with a region of the keyspace to coordinate (the “coordination region”);
at the second node, computing a second cryptographic fingerprint of the data associated with the coordination region;
comparing the first cryptographic fingerprint and the second cryptographic fingerprint; and
when the first cryptographic fingerprint is different than the second cryptographic fingerprint, communicating a state change message to synchronize the state between the first node and the second node.

16. The instructions of claim 15 wherein at least one dimension of the region is a temporal dimension.

17. The instructions of claim 15 wherein at least one dimension of the region is defined by a logical clock.

18. The instructions of claim 15 wherein the state change message updates stored state that is temporally or logically older using information that is temporally or logically newer.

19. The instructions of claim 15 further comprising instructions which, when the first cryptographic fingerprint is different than the second cryptographic fingerprint, partition the region into a first sub-region and a second sub-region; and iteratively use the first sub-region and the second sub-region as the coordination region.

20. The instructions of claim 19 wherein the partitioning and comparing of the coordination region between the first node and the second node is performed recursively until at least one dimension of the coordination region reaches the smallest discrete size allowed in that dimension.
